(19) United States
(12) Patent Application Publication
(10) Pub. No.: US 2009/0059616 A1
(43) Pub. Date: Mar. 5, 2009

(54) Illumination light assembly with self-retaining lightpipe for minimizing specular reflection in electro-optical reader

(76) Inventors: Carl Wittenberg, Water Mill, NY (US); Igor Vinogradov, Bay Shore, NY (US)

Correspondence Address: Kirschstein, Ottinger, Israel & Schiffmiller, P.C., 425 Fifth Avenue, New York, NY, 10016, US

(21) Appl. No.: 11/897,488

(22) Filed: Aug. 30, 2007

(51) Int. Cl. F21V 8/00; G02B 5/02

(52) U.S. Cl. 362/558; 362/551

(57) ABSTRACT

An assembly for illuminating indicia includes a chassis, an illuminator for emitting illumination light, and a self-retaining lightpipe constituted of an optical material and non-adhesively mounted on the chassis with a snap action in an assembled position. The lightpipe is optically aligned with the illuminator in the assembled position, for optically guiding the illumination light from the illuminator to the indicia. The lightpipe has a textured exit surface, preferably with a predetermined scattering directionality, for scattering the illumination light exiting therefrom toward the indicia in a controlled manner to minimize specular reflection.

### BACKGROUND OF THE INVENTION

Various moving beam and imaging electro-optical readers have previously been developed for reading both one- and two-dimensional bar code symbols appearing on a label, or on a surface of a target. The bar code symbol itself is a coded pattern of indicia. Generally, the readers electro-optically transform graphic indicia of the symbols into electrical signals, which are decoded into alphanumeric characters. The resulting characters describe the target and/or some characteristic of the target with which the symbol is associated. Such characters typically comprise input data to a data processing system for applications in point-of-sale processing, inventory control, article tracking and the like.

The imaging reader includes a solid-state imager having a one- or two-dimensional array of cells or photosensors which correspond to image elements or pixels in a field of view of the imager. A collection lens captures either ambient light scattered from the symbol in the case of a brightly lit environment or, more often, captures illumination light directed through a window at the symbol for scattering therefrom in the case of a dimly lit environment in response to actuation of a trigger. The captured light passes through the window to the imager, which may advantageously be a one- or two-dimensional charge coupled device (CCD) or a complementary metal oxide semiconductor (CMOS) device and includes associated circuits for producing electronic signals indicative of the captured light and corresponding to a one- or two-dimensional array of pixel information over the field of view. The electronic signals may be processed by a microprocessor either locally or sent to, and processed in, a remote host to read the symbol from the captured light.

A problem associated with known imaging readers involves specular reflection, which may prevent a successful decoding and reading of the symbol. When the illumination light generated by an illuminator impinges on a surface, such as a symbol on a label, the reflected light has a specular component and a scattered component. The scattered component radiates in all directions, and its intensity is proportional to the contrast between the darker bars and the lighter spaces of the symbol. It is the scattered component of the reflected light which carries the information about the data encoded in the symbol that is detected and processed by the imager to decode and read the symbol.

The specular component, on the other hand, is a mirror-like reflection wherein the illumination light is reflected according to the principle that the angle of reflection is equal to the angle of incidence. This mirror-like reflection is commonly encountered when the symbol is printed on a label having a glossy finish, or overlaid with cellophane, foil, or film packaging. The specular component is the major constituent of the reflected light, but is not that constituent which is used by the imager to decode and read the symbol, because the intensity of the specular component is more dependent on surface finish as opposed to the contrast between the darker bars and the lighter spaces of the symbol. The specular component typically does not carry information about the data encoded in the symbol. The specular component, also called glare, is typically much brighter than the scattered component, particularly when a symbol is printed on a label having a glossy finish, or overlaid with cellophane, foil, or film packaging, or is wrinkled. Glare can overload and “blind” the imager.

There are many ways to minimize specular reflection, one of which is to direct the illumination light at the symbol at a substantially steep angle of incidence. For this purpose, it is known to use a lightpipe to guide the illumination light from the illuminator through the window toward the symbol at such a steep incidence angle, thereby reflecting the specular component well away from the imager at the same steep reflection angle. On the other hand, since the scattered component, which carries the useful information about the symbol, is scattered in all directions, the scattered component will still be detected by the imager.

As advantageous as the imaging reader is in capturing data as a stand-alone data capture system, such a reader can be a relatively large and expensive component in assembly and manufacture, especially if it is installed in an apparatus in which the reader is a subsystem. For example, a coffee maker is an example of an apparatus in which the reader may be installed to read symbols on packets of coffee in order to instruct the coffee maker how to brew a particular packet. The reader is a subsidiary system in the coffee maker and, therefore, its design must be optimized such that its size, as well as its assembly and manufacturing costs, are minimized.

It is known to use an adhesive to adhere the lightpipe, as described above, in a fixed position in front of the illuminator. However, the lightpipe must be optically and physically and rapidly positioned with a high degree of accuracy relative to the imager. This is difficult to achieve economically when an adhesive is employed, and where the available room is small. A manufacturer is not likely to use an uneconomic, large-sized reader, especially in an apparatus with little room to spare.

Moreover, in some cases, the symbol-bearing label is so glossy, or so overlaid with cellophane, foil, or film packaging, or so wrinkled, that illumination at a steep angle may not be sufficient to eliminate specular reflection completely. Polarizing filters could be used to filter out the specular reflection, but they add cost to the reader and also greatly attenuate the intensity of the captured light.

### SUMMARY OF THE INVENTION

One feature of this invention resides, briefly stated, in an assembly for, and a method of, illuminating indicia. The assembly is advantageously employed in an imaging reader for electro-optically reading indicia, such as bar code symbols, by capturing illumination and/or ambient light scattered from the symbols with an array of image sensors.

The assembly includes a chassis, an illuminator for emitting illumination light, and a self-retaining lightpipe constituted of a light-transmissive optical material. The lightpipe is non-adhesively mounted, preferably with a snap action, on the chassis in an assembled position. The lightpipe is optically aligned with the illuminator in the assembled position, for optically guiding the illumination light from the illuminator toward the indicia. All six degrees of freedom in space for the lightpipe are completely constrained in the assembled position.

In accordance with one feature of this invention, the lightpipe is rapidly assembled with a high degree of accuracy relative to the illuminator, without adhesives, and retains itself in the assembled position. This reduces assembly and manufacturing costs and promotes the use of the reader as a miniature component in a non-stand-alone apparatus, such as the coffee maker described above, or a myriad of other apparatuses, such as a telephone, mobile computer, or the like where space is at a premium.

In a preferred embodiment, the illuminator and the chassis are mounted on a printed circuit board. An imager for sensing the illumination light from the indicia is also mounted on the board. The board lies in a plane, and the lightpipe includes an inclined portion extending at a steep incidence angle, e.g., 45 degrees, relative to the plane of the board to minimize specular reflection.

The chassis has walls bounding a pair of compartments, and the lightpipe has a pair of legs respectively received in the compartments. One of the walls of each compartment is resilient and has a projection, and each leg of the lightpipe has a recess for receiving the projection. Each projection yields resiliently from an initial unstressed condition during insertion of the lightpipe into the chassis to a stressed condition in the assembled position, thereby anchoring the lightpipe within the compartments due to the constant urging of the projections into the recesses back to the initial condition. The legs of the lightpipe symmetrically straddle the illuminator in the assembled position. The legs contact the chassis in the assembled position and maintain the lightpipe at a predetermined distance from the illuminator.

In accordance with another feature of this invention, the lightpipe has a textured exit surface for dispersing the illumination light exiting therefrom toward the indicia. Preferably, the textured exit surface has a predetermined scattering directionality to diffuse the illumination light exiting therefrom. Instead of texturing the exit surface, a diffuser film could be applied thereto. This feature further minimizes specular reflection, and polarizing filters need not be used to filter out the specular reflection.

The method of illuminating indicia includes the steps of emitting illumination light from the illuminator, and non-adhesively mounting the self-retaining lightpipe constituted of an optical material on the chassis in an assembled position. The lightpipe is optically aligned with the illuminator in the assembled position, for optically guiding the illumination light from the illuminator to the indicia.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of an imaging reader for reading indicia in which a light illumination assembly in accordance with this invention is employed;

FIG. 2 is a block circuit diagram of various components of the imaging reader of the type shown in FIG. 1;

FIG. 3 is an exploded, perspective view of a lightpipe and a chassis used in a light illumination assembly in accordance with this invention;

FIG. 4 is an assembled, perspective view of the lightpipe mounted on the chassis of FIG. 3 for assembly with a printed circuit board of the light illumination assembly;

FIG. 5 is an enlarged, sectional view taken in the direction of the arrows on line 5-5 of FIG. 4;

FIG. 6 is an enlarged, sectional view taken in the direction of the arrows on line 6-6 of FIG. 4;

FIG. 7 is a front, elevational view of the assembly of FIG. 4; and

FIG. 8 is an enlarged, developed view of a textured exit surface of the lightpipe.

### DETAILED DESCRIPTION OF THE PREFERRED EMBODIMENTS

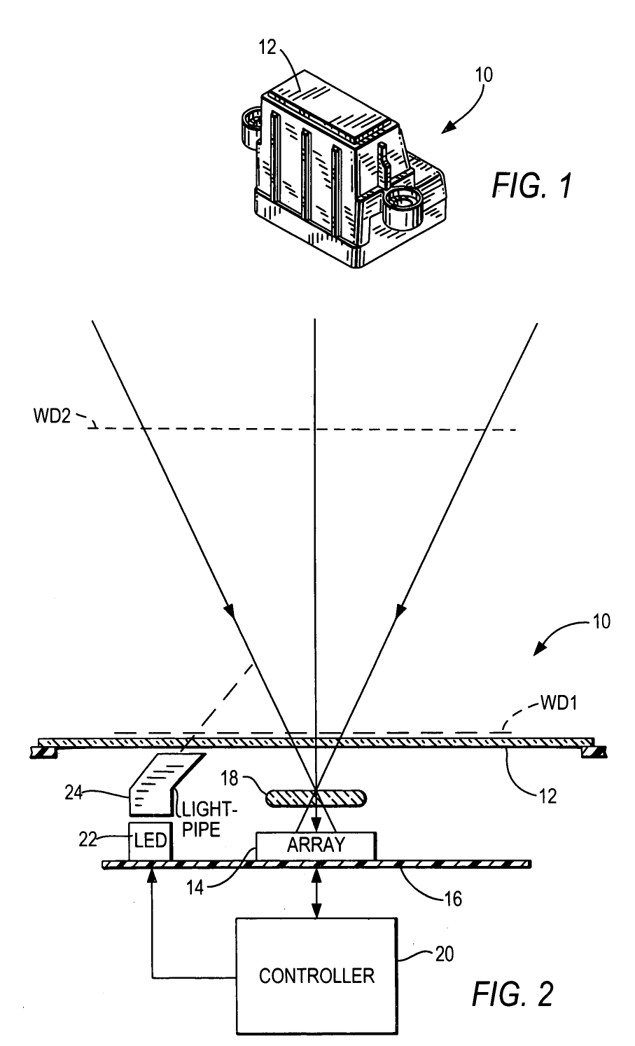

Reference numeral 10 in FIG. 1 generally identifies a data capture system or an electro-optical imaging reader for electro-optically reading indicia, such as bar code symbols, by capturing illumination and/or ambient light reflected or scattered from the symbols with an array of image sensors. In use, an operator presents each symbol to be read to a generally planar window 12. The reader 10 can be used as a stand-alone device, but has been especially designed herein to be portable, miniature, lightweight and inexpensive so that it can be readily installed as a subsidiary component in an apparatus operative for performing other functions.

As shown in FIG. 2, the imaging reader 10 includes an imager 14 supported on a printed circuit board 16 and a focusing collection or imaging lens 18 in front of the imager. The imager 14 is a solid-state device, for example, a CCD or a CMOS device and preferably has a linear array of addressable image sensors operative for sensing light passing through the window 12 and captured by the lens 18. The light is reflected or scattered from a target symbol, for example, a one-dimensional symbol, over a field of view and located in a working range of distances between a close-in working distance (WD1) and a far-out working distance (WD2). In a preferred embodiment, WD1 is about one inch from the imager array 14 and generally coincides with the window 12, and WD2 is about two inches from the window 12.

An illuminator is also mounted in the reader and preferably includes a light source, e.g., a light emitting diode (LED) 22, mounted on the board 16 to illuminate the target symbol especially in a dimly lit environment where ambient light is insufficient for the reader to operate. A lightpipe 24 is operative for optically guiding and delivering the illumination light from the LED 22 through the window 12 to the indicia. To help minimize specular reflection, an upper portion of the lightpipe 24 is inclined at a steep angle of inclination, e.g., 45 degrees, relative to the window 12 and the board 16. Hence, the specular component of the light reflected from the indicia is directed well away from the imager at the same steep angle of inclination. A lower portion of the lightpipe 24 is generally perpendicular to the window 12 and the board 16.

As also shown in FIG. 2, the imager 14 and the LED 22 are operatively connected to a controller or microprocessor 20 operative for controlling the operation of these components. Preferably, the microprocessor is the same as the one used for decoding the light from the symbol and for processing the captured target symbol images.

In operation, the microprocessor 20 sends a command signal to the LED 22 to pulse the LED for a short time period of 500 microseconds or less, and energizes the imager 14 to collect light captured by the lens 18 from the symbol substantially only during said time period. A typical array needs about 33 milliseconds to read the entire target image and operates at a frame rate of about 30 frames per second. The array may have on the order of one thousand, preferably 1500, addressable image sensors.

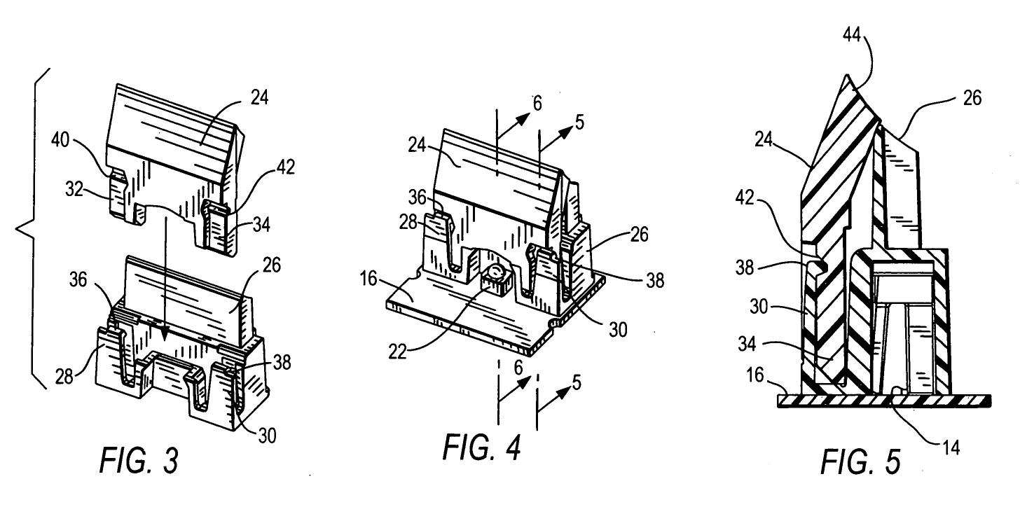

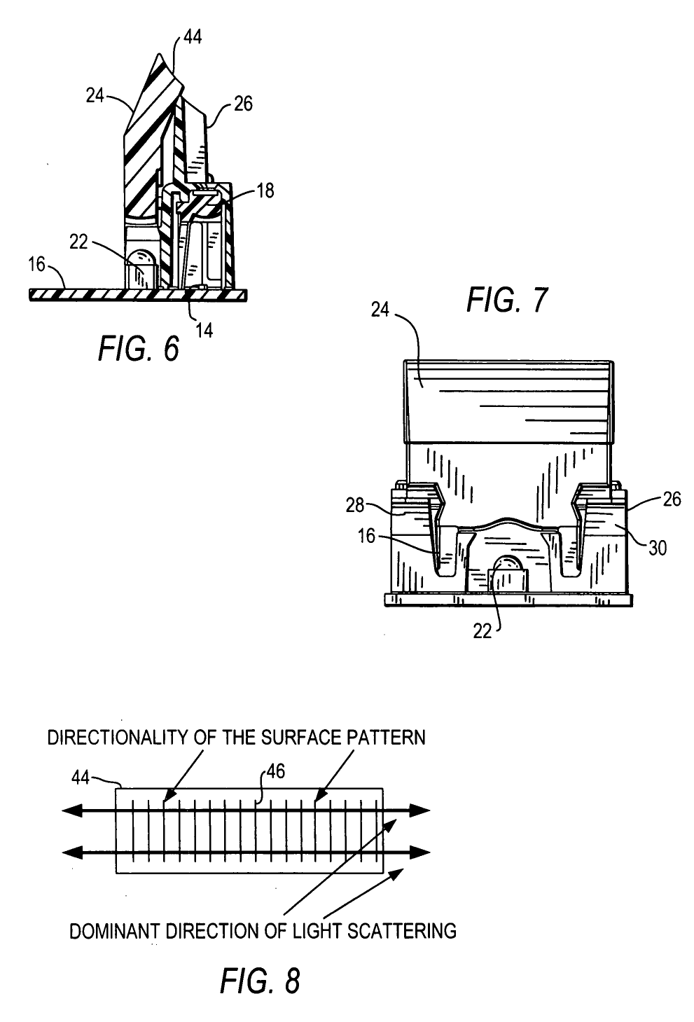

In accordance with one feature of this invention, the lightpipe 24 is rapidly assembled in a fixed assembled position in a light illumination assembly (see FIGS. 3-7) with a high degree of accuracy relative to the illuminator LED 22, without adhesives, and the lightpipe 24 retains itself in the assembled position. All six degrees of freedom in space for the lightpipe 24 are completely constrained in the assembled position.

The light illumination assembly comprises a chassis 26 of molded one-piece construction and has a pair of outer walls 28, 30 bounding a pair of compartments. The lightpipe 24 is constituted of a light-transmissive, optical material, preferably having optical power, and is non-adhesively mounted within the compartments in the assembled position shown in FIGS. 4-7. The lightpipe 24 is of molded one-piece construction and has a pair of legs 32, 34 received within the compartments with a snap action in the assembled position. The solid-state imager 14 is optically aligned with the collection lens 18 mounted in another internal compartment of the chassis, and is operative for sensing the illumination light optically modified and captured by the lens 18 and projected onto the imager.

In a preferred embodiment, each of the outer walls 28, 30 bounding each compartment is resilient and has a projection 36, 38, and each leg 32, 34 of the lightpipe 24 has a recess 40, 42 for receiving the respective projection 36, 38. Each projection 36, 38 yields resiliently from an initial unstressed condition during insertion of the lightpipe 24 into the chassis to a stressed condition in the assembled position, thereby anchoring the lightpipe 24 within the compartments due to the constant urging of the projections 36, 38 into the recesses 40, 42 back to the initial condition. Each projection 36, 38 is wedge-shaped and is inclined at about a 15 degree angle relative to the horizontal. The legs 32, 34 of the lightpipe 24 symmetrically straddle the illuminator LED 22 in the assembled position. The legs 32, 34 contact the chassis 26 in the assembled position and maintain the lightpipe 24 at a predetermined distance from the illuminator LED 22.

In accordance with another feature of this invention, the lightpipe 24 has a textured exit surface 44, preferably concave, for dispersing the illumination light exiting therefrom through the window 12 toward the indicia. Preferably, the textured exit surface 44 has a predetermined scattering directionality, as shown in FIG. 7, to diffuse the illumination light exiting therefrom. More particularly, a plurality of shallow grooves 46 is formed in a directional surface pattern in the exit surface. The grooves 46 are oriented to be generally parallel to the bars of the symbol to be read. Other textured surface patterns could be employed. The dominant direction of the light scattering from the exit surface is depicted in FIG. 7. Light gets scattered only along the symbol, which does not decrease the incident angle of the light exiting the lightpipe 24, but increases the angle due to additional light coming from multiple points along the lightpipe. The directional diffuser scatters the light along the field of view of the imaging lens 18 without scattering the light in other directions which are not detectable by the imager. This feature further minimizes specular reflection.

Thus, the lightpipe 24 is rapidly assembled with a high degree of accuracy relative to an illuminator LED 22, without adhesives, and retains itself in the assembled position. This reduces assembly and manufacturing costs and promotes the use of the reader either as a stand-alone system, or as a miniature component in a non-stand-alone apparatus, such as the coffee maker described above, or a myriad of other apparatuses, such as a telephone or mobile computer.

It will be understood that each of the elements described above, or two or more together, also may find a useful application in other types of constructions differing from the types described above.

While the invention has been illustrated and described as embodied in an illumination light assembly, especially for minimizing specular reflection, in an electro-optical reader and method, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

We claim:

1. An assembly for illuminating indicia, comprising:
a chassis;
an illuminator for emitting illumination light; and
a self-retaining lightpipe constituted of an optical material and non-adhesively mounted on the chassis in an assembled position, the lightpipe being optically aligned with the illuminator in the assembled position for optically guiding the illumination light from the illuminator toward the indicia.

2. The assembly of claim 1, and a printed circuit board on which the illuminator and the chassis are mounted.

3. The assembly of claim 2, and an imager on the board, for sensing the illumination light from the indicia.

4. The assembly of claim 2, wherein the board lies in a plane, and wherein the lightpipe includes an inclined portion extending at an incidence angle relative to the plane of the board.

5. The assembly of claim 1, wherein the lightpipe is mounted on the chassis with a snap action.

6. The assembly of claim 1, wherein the chassis has walls bounding a pair of compartments, and wherein the lightpipe has a pair of legs respectively received in the compartments.

7. The assembly of claim 6, wherein one of the walls of each compartment is resilient and has a projection, and wherein each leg of the lightpipe has a recess for receiving the projection.

8. The assembly of claim 6, and a printed circuit board on which the illuminator and the chassis are mounted, and wherein the legs of the lightpipe straddle the illuminator in the assembled position.

9. The assembly of claim 1, wherein the lightpipe has a textured exit surface for dispersing the illumination light exiting therefrom toward the indicia.

10. The assembly of claim 9, wherein the textured exit surface has a predetermined scattering directionality to diffuse the illumination light exiting therefrom.

11. An electro-optical reader for capturing light from indicia, comprising:
a housing having a window; and
an assembly in the housing, for illuminating the indicia, including
a chassis;
an illuminator for emitting illumination light through the window; and
a self-retaining lightpipe constituted of an optical material and non-adhesively mounted on the chassis in an assembled position, the lightpipe being optically aligned with the illuminator in the assembled position for optically guiding the illumination light from the illuminator through the window toward the indicia.

12. The reader of claim 11, wherein the window lies in a plane, and wherein the lightpipe includes an inclined portion extending at an incidence angle relative to the plane of the window.

13. The reader of claim 11, wherein the lightpipe has a textured exit surface for dispersing the illumination light exiting therefrom through the window toward the indicia.

14. An assembly for illuminating indicia, comprising:
chassis means;
illuminator means for emitting illumination light; and
self-retaining lightpipe means constituted of an optical material and non-adhesively mounted on the chassis means in an assembled position, the lightpipe means being optically aligned with the illuminator means in the assembled position for optically guiding the illumination light from the illuminator means toward the indicia.

15. A method of illuminating indicia, comprising the steps of:
emitting illumination light from an illuminator; and
non-adhesively mounting a self-retaining lightpipe constituted of an optical material on a chassis in an assembled position, the lightpipe being optically aligned with the illuminator in the assembled position for optically guiding the illumination light from the illuminator toward the indicia.

16. The method of claim 15, and mounting the illuminator and the chassis on a printed circuit board.

17. The method of claim 16, and sensing the illumination light from the indicia with an imager on the board.

18. The method of claim 16, wherein the board lies in a plane, and extending an inclined portion of the lightpipe at an incidence angle relative to the plane of the board.

19. The method of claim 15, wherein the mounting step is performed by mounting the lightpipe on the chassis with a snap action.

20. The method of claim 15, and texturing an exit surface of the lightpipe for dispersing the illumination light exiting therefrom toward the indicia.

21. The method of claim 20, wherein the texturing is performed by texturing the exit surface with a predetermined scattering directionality to diffuse the illumination light exiting therefrom.

22. A lightpipe for optically guiding illumination light toward indicia to be electro-optically read, comprising:
a body of light-transmissive optical material having a first portion extending along a longitudinal direction, and a second portion inclined at an angle relative to the first portion, the inclined second portion having a textured exit surface for scattering the illumination light exiting therefrom toward the indicia.
